(19) United States
(12) Patent Application Publication
(10) Pub. No.: US 2018/0219973 A1
(43) Pub. Date: Aug. 2, 2018

(54) Integrated Management Apparatus and Method for Heterogeneous Devices Using Instances of Vendor Classes

(71) Applicant: FutureSystems, Inc., Seongnam-si (KR)

(72) Inventor: Moon Chang Chae, Gunpo-si (KR)

(21) Appl. No.: 15/433,036

(22) Filed: Feb. 15, 2017

(30) Foreign Application Priority Data
Jan. 31, 2017 (KR) 10-2017-0014045

(51) Int. Cl. H04L 29/08

(52) U.S. Cl. CPC H04L 67/34

(57) ABSTRACT

Provided is an integrated management apparatus and method for heterogeneous devices. The integrated management method may include classifying Internet protocol (IP) based devices to be managed based on a domain grouped for each field; defining a hierarchical class for each domain based on a field classification corresponding to each domain; defining a class of a bottom layer among the hierarchical classes as a vendor class corresponding to a device of a specific vendor; and mapping an instance of the vendor class to the device. The vendor class converts a common application programming interface (API) of an upper layer to an API corresponding to the device of the specific vendor, and the device is controlled by the API corresponding to the device of the specific vendor used by the instance of the vendor class.

### CROSS-REFERENCE TO RELATED APPLICATION(S)

This application claims the priority benefit of Korean Patent Application No. 10-2017-0014045 filed on Jan. 31, 2017, in the Korean Intellectual Property Office, the disclosure of which is incorporated herein by reference for all purposes.

### BACKGROUND

### 1. Field

One or more example embodiments relate to an apparatus and method for integrally managing different vendors and different types of devices.

### 2. Description of Related Art

With the diversification of a vendor manufacturing an Internet protocol (IP) based device, an application programming interface (API) that includes an instruction for performing the same function is different for each device or a vendor of the corresponding device.

For example, an API for controlling a screen on Windows manufactured by IBM is different from an API for controlling a screen on Macintosh (MAC) manufactured by Apple. Accordingly, vendors configured to manage devices manufactured by different vendors use a variety of APIs to manage the devices. Also, the vendor needs to verify a device to which each of APIs for performing a specific operation is to be input.

Accordingly, there is a need for a management method so that devices manufactured or used by different vendors may perform the same operation using a common API.

### SUMMARY

At least one example embodiment provides an apparatus and method for managing different heterogeneous devices using a common application programming interface (API) that may control devices by matching each of instances of a vendor class converting the common API to an API corresponding to a device of a specific vendor, and by converting an instruction input to the common API to an API corresponding to a device to which each of the instances of the vendor class is matched.

According to an aspect of at least one example embodiment, there is provided an integrated management method for heterogeneous devices, the method including classifying Internet protocol (IP) based devices to be managed based on a domain grouped for each field; defining a hierarchical class for each domain based on a field classification corresponding to each domain; defining a class of a bottom layer among the hierarchical classes as a vendor class corresponding to a device of a specific vendor; and mapping an instance of the vendor class to the device. The vendor class converts a common API of an upper layer to an API corresponding to the device of the specific vendor, and the device is controlled by the API corresponding to the device of the specific vendor used by the instance of the vendor class.

A class of a lower layer among the hierarchical classes may inherit a common API of a class of the upper layer and may include an API different from those of classes of the same layer.

The vendor class may match an instruction for performing the same function as an instruction included in the common API of the upper layer among APIs corresponding to the device of the specific vendor to the instruction included in the common API, may in response to receiving the instruction included in the common API of the upper layer, retrieve an instruction that is matched to the received instruction, and may output the retrieved instruction as the instance using the API corresponding to the device of the specific vendor.

The instance may be generated for each version of the device of the specific vendor, and an instance matched to the device of the specific vendor may be changed in response to a change of a version of the device of the specific vendor.

According to an aspect of at least one example embodiment, there is provided a device control method including receiving an instruction using a common API; identifying a vendor class matched to a device that is to execute the instruction; retrieving an instruction for performing the same function as the received instruction among APIs corresponding to a device of a specific vendor using the identified vendor class; and controlling the device of the specific vendor using an instance of the identified vendor class in response to the retrieved instruction being output as the instance of the identified vendor class using an API corresponding to the device of the specific vendor.

According to an aspect of at least one example embodiment, there is provided an integrated management apparatus for heterogeneous devices, the apparatus including a device classifier configured to classify IP based devices to be managed based on a domain grouped for each field; and a device definer configured to define a hierarchical class for each domain based on a field classification corresponding to each domain, to define a class of a bottom layer among the hierarchical classes as a vendor class corresponding to a device of a specific vendor, and to map an instance of the vendor class to the device. The vendor class converts a common API of an upper layer to an API corresponding to the device of the specific vendor, and the device may be controlled by the API corresponding to the device of the specific vendor used by the instance of the vendor class.

A class of a lower layer among the hierarchical classes may inherit a common API of a class of the upper layer and may include an API different from those of classes of the same layer.

The vendor class may match an instruction for performing the same function as an instruction included in the common API of the upper layer among APIs corresponding to the device of the specific vendor to the instruction included in the common API, may in response to receiving the instruction included in the common API of the upper layer, retrieve an instruction that is matched to the received instruction, and may output the retrieved instruction as the instance using the API corresponding to the device of the specific vendor.

The instance may be generated for each version of the device of the specific vendor, and an instance matched to the device of the specific vendor may be changed in response to a change of a version of the device of the specific vendor.

According to example embodiments, it is possible to manage different heterogeneous devices using a common API by controlling the devices by matching each of instances of a vendor class converting the common API to an API corresponding to a device of a specific vendor, and by converting an instruction input to the common API to an API corresponding to a device to which each of the instances of the vendor class is matched.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an integrated management apparatus for heterogeneous devices according to an example embodiment;

FIG. 2 illustrates an example of a hierarchical class defined by an integrated management apparatus for heterogeneous devices according to an example embodiment;

FIG. 3 illustrates an example of a vendor class defined by an integrated management apparatus for heterogeneous devices according to an example embodiment;

FIG. 4 illustrates an example of a virtual device generated by an integrated management apparatus for heterogeneous devices according to an example embodiment;

FIG. 5 is a flowchart illustrating an integrated management method for heterogeneous devices according to an example embodiment; and

FIG. 6 is a flowchart illustrating a process of controlling, by an instance of a vendor class, a device according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Hereinafter, example embodiments will be described with reference to the accompanying drawings. An integrated management method for heterogeneous devices according to an example embodiment may be performed by an integrated management apparatus for heterogeneous devices.

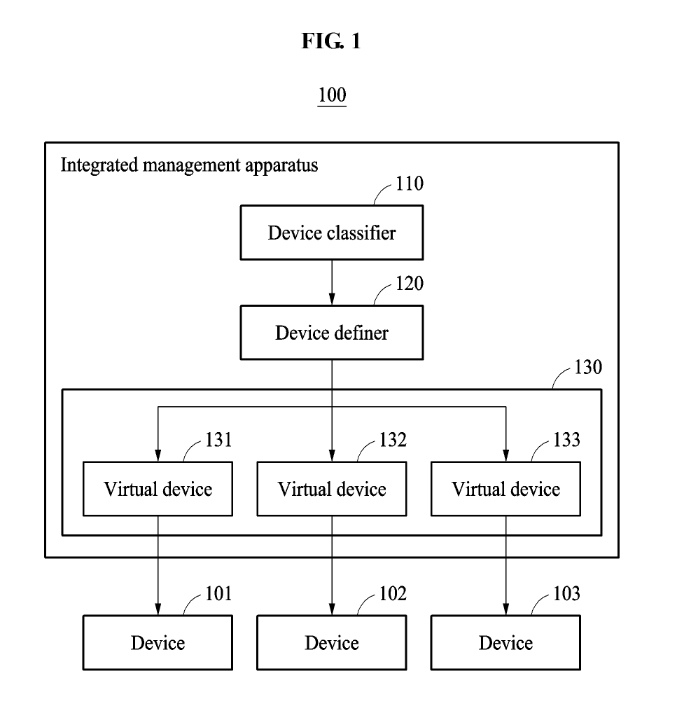

FIG. 1 is a diagram illustrating an integrated management apparatus for heterogeneous devices (hereinafter, also referred to as an integrated management apparatus) according to an example embodiment.

Referring to FIG. 1, an integrated management apparatus 100 may include a device classifier 110, a device definer 120, and a plurality of virtual devices 130. Here, each of the device classifier 110, the device definer 120, and the plurality of virtual devices 130 may be a module included in a different process or a single process.

The integrated management apparatus 100 may manage devices of different vendors using a common application programming interface (API) or a standard API.

The device classifier 110 may classify Internet protocol (IP) based devices to be managed based on a domain grouped for each field.

For example, the device classifier 110 may set each of a network, a security, a host, a service, and Internet of things (IoT) to a different field, and may set a group of devices corresponding to each field as a domain.

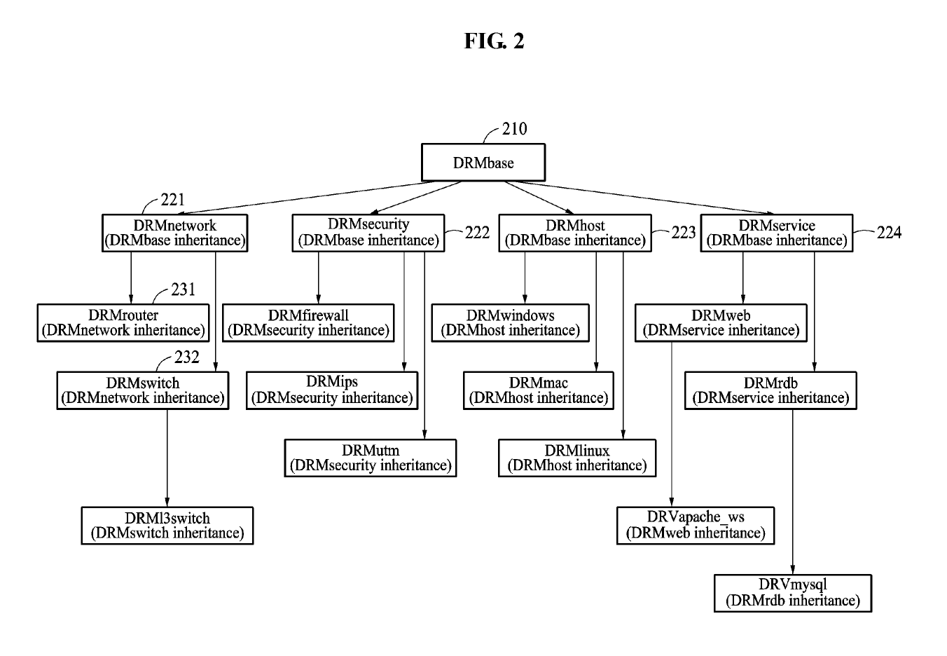

The device definer 120 may define a hierarchical class for each domain based on a field classification corresponding to each domain. Here, a class of a lower layer among hierarchical classes may inherit a common API of a class of an upper layer and may include an API different from those of classes of the same layer. A hierarchical class defined by the device definer 120 will be further described with reference to FIG. 2.

Also, each of the hierarchical classes may classify a common API of a corresponding layer based on a method. A hierarchical structure of a class defined by the device definer and a common API of the class included in the hierarchical structure may vary based on example embodiments.

The device definer 120 may define a class of a bottom layer among the hierarchical classes as a vendor class corresponding to a device of a specific vendor. Here, the vendor class may be a class that converts the common API of the upper layer to an API corresponding to the device of the specific vendor.

In detail, the device definer 120 may match an instruction for performing the same function as an instruction included in the common API of the upper layer among APIs corresponding to the device of the specific vendor to the instruction included in the common API, and may include the same in the vendor class.

For example, referring to Table 1, when a vendor class corresponding to Cisco among vendors is “DRNcatalyst” and an instruction using a common API is “DRMswitch/set_acl”, the device definer 120 may match the instruction to an instruction, “access-list 11 deny tcp 10.20.30.0.0.0.0.255”, which is an instruction for performing the same function as “DRMswitch/set_acl”, and may include the same in a vendor class.

Also, referring to Table 1, the device definer 120 may match an instruction for performing a function corresponding to a corresponding function in each of the devices 101, 102, and 103 to an instruction included in the common API for each vendor class to the instruction included in the common API, and may include the matched instruction in a corresponding vendor class.

TABLE 1

| DRM Class/common | DRM vendor | | Corresponding function (CLI |
|---|---|---|---|
| function | class | Vendor | instruction, etc.) |
| DRMswitch/set_acl | DRNcatalyst | Cisco | access-list 11 deny tcp |
| | | | 10.20.30.0.0.0.0.255 |
| | DRNjuniper | Juniper | firewall{filter 102{term |
| | | | TERM_NAME{from{source- |
| | | | address{10.194.0.14/32;}destination- |
| | | | address{220.232.29.225/32;}protocol |
| | | | icmp;}then accept;}} |
| | DRNomnisw | Omniswitch | policy condition fromIP1toIP3 |
| | | | source ip 10.0.0.100 destination ip |
| | | | 192.0.0.0 mask 255.0.0.0 |
| DRMlinux/install_pkg | DRHubuntu | Canonical | apt-get install pkg |
| | DRHCentoOS | CentOS | yum install pkg |
| | | OpenSource | |

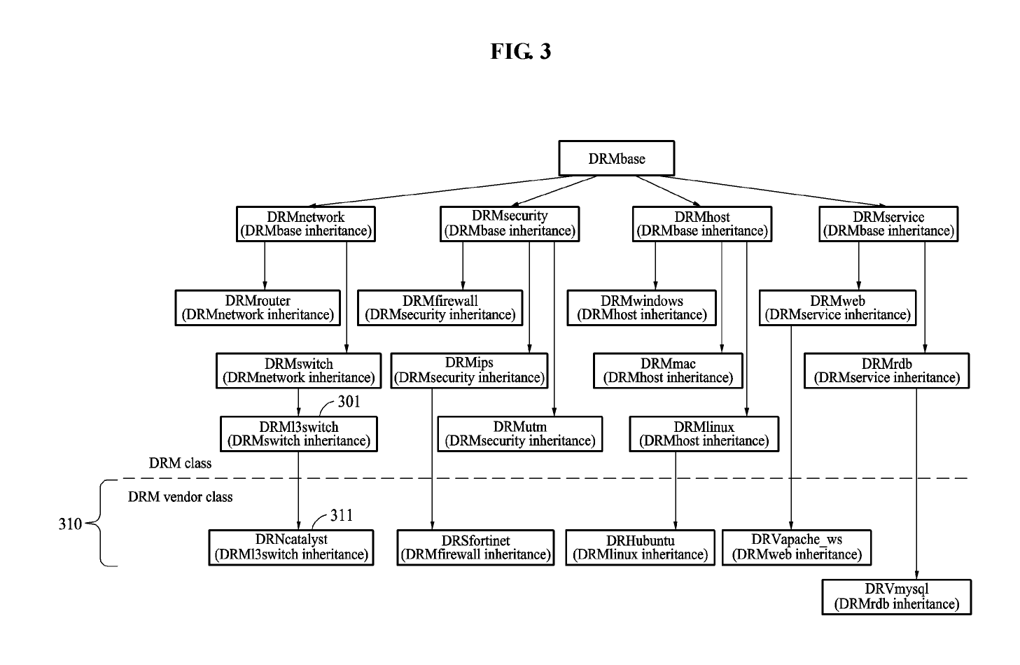

In response to receiving the instruction included in the common API of the upper layer, the vendor class may retrieve an instruction that is matched to the received instruction. The vendor class may output the retrieved instruction as the instance using the API corresponding to the device of the specific vendor. A relationship between the vendor class and the upper layer will be further described with reference to FIG. 3.

The device definer 120 may map virtual devices 131, 132, and 133 each, which is an instance of the vendor class, to the devices 101, 102, and 103, respectively. That is, the device definer 120 may generate the virtual devices 131, 132, and 133 included in the virtual devices 130 and may perform device relational mapping (DRM) of mapping the generated virtual devices 131, 132, and 133 to the devices 101, 102, and 103.

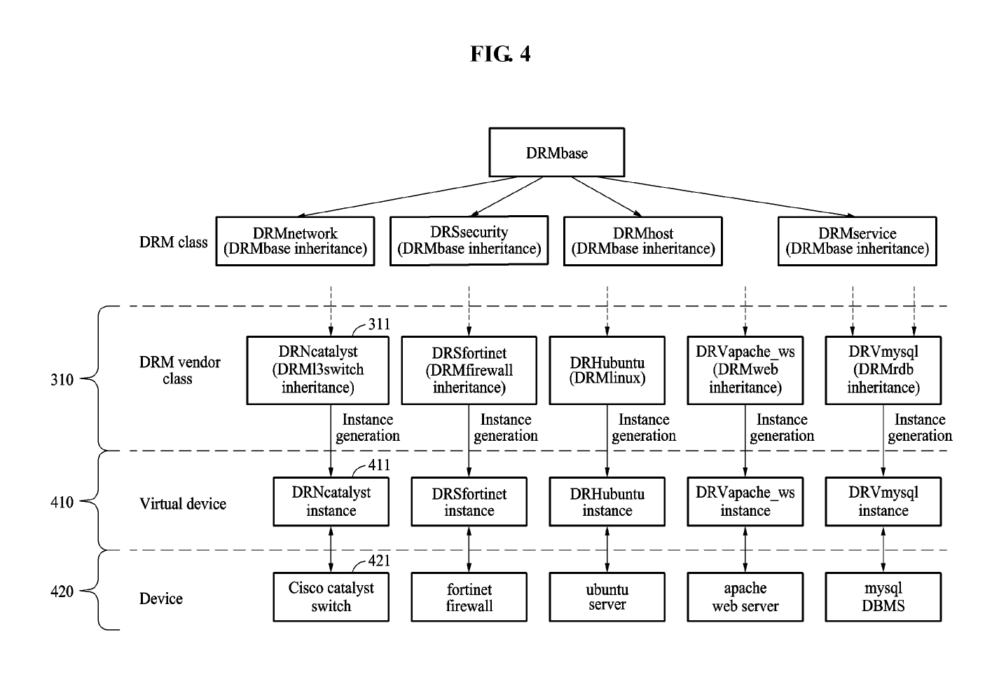

A relationship among the virtual devices 130, a hierarchical class, and the devices 101, 102, and 103 will be further described with reference to FIG. 4.

The virtual device 130 may be an instance of the vendor class that defines a device of a specific vendor. Also, the virtual device 130 may control a device mapped to the virtual device 130 using an API corresponding to the device of the specific vendor. In detail, the virtual device 130 may be a process that is one-to-one mapped to each of the devices 101, 102, and 103 and manages the matched device. The virtual device 130 may create, read, update, and delete setting information of the matched device.

The virtual device 130 or the instance of the vendor class may be generated for each version of the device of the specific vendor. Also, in response to a change of the version of the device of the specific vendor, the virtual device 130 matched to the device of the specific vendor or the instance of the vendor class may be changed.

According to example embodiments, an integrated management apparatus for heterogeneous devices may manage different heterogeneous devices using a common API by controlling the devices by matching each of instances of a vendor class converting the common API to an API corresponding to a device of a specific vendor, and by converting an instruction input to the common API to an API corresponding to a device to which each of the instances of the vendor class is matched.

FIG. 2 illustrates an example of a hierarchical class defined by an integrated management apparatus for heterogeneous devices according to an example embodiment.

Each of hierarchical classes may inherit a common API of an upper layer.

Referring to FIG. 2, for example, DRMnetwork 221, DRMsecurity 222, DRMhost 223, and DRMservice 224 that are classes of a second layer may inherit DRMbase corresponding to a common API of a top class, DRMbase 210.

Also, DRMrouter 231 and DRMswitch 232 that are classes of a lower layer of DRMnetwork 221 may inherit DRMnetwork that is a common API of DRMnetwork 221. Here, since DRMnetwork 221 has inherited DRMbase, DRMrouter 231 and DRMswitch 232 may inherit all of DRMbase and DRMnetwork.

Also, DRMfirewall, DRMips, and DRMutm that are classes of a lower layer of DRMsecurity 222 may inherit DRMsecurity that is a common API of DRMsecurity 222.

That is, in the case of hierarchical classes defined by the device definer 120, classes of the same layer, for example, a third layer may inherit different common APIs based on an upper layer.

Also, each of classes of a lower layer may inherit all of common APIs of ancestors. For example, DRM13switch may inherit all of DRMswitch corresponding to the common API of DRMswitch 232 that is a class of an upper layer, DRMnetwork corresponding to the common API of DRMnetwork 221 that is the class of the upper layer of DRMswitch 232, and DRMbase corresponding to the common API of DRMbase 210 that is the class of the upper layer of DRMnetwork 221. In the example embodiment of FIG. 2, since DRMbase 210 corresponds to the top class, all of the classes may inherit the common API, DRMbase, of DRMbase 210.

FIG. 3 illustrates an example of a vendor class defined by an integrated management apparatus for heterogeneous devices according to an example embodiment. Referring to FIG. 3, remaining classes excluding a vendor class 310 from among hierarchical classes may be indicated as DRM classes and the vendor classes 310 may be indicated as a DRM vendor class.

Referring to FIG. 3, the vendor class 310 may be a class of a bottom layer among the hierarchical classes. Also, the vendor class 310 may correspond to a vendor and may configure a common API method of an upper layer to correspond to a device of a corresponding vendor.

For example, a vendor refers to a vendor, such as SAMSUNG and LG, that manufactures a device. The vendor class 310 may convert a common API method to an API corresponding to a device manufactured or used by the vendor.

For example, among the vendor classes 310, DRNcatalyst 311 may inherit a common API, DRM13switch, from an upper layer, DRM13switch 301. DRNcatalyst 311 may configure the inherited DRM13switch as an API corresponding to a device of a vendor corresponding to DRNcatalyst 311.

FIG. 4 illustrates an example of a virtual device generated by an integrated management apparatus for heterogeneous devices according to an example embodiment.

Referring to FIG. 4, a virtual device 410 generated by the integrated management apparatus 100 may be an instance generated by the vendor class 310 that is a DRM vendor class. The virtual device 410 may be defined as a meta device.

Here, the virtual device 410 may be one-to-one mapped to an actual device 420 by the device definer 120. The virtual device 410 may manage the mapped actual device 420.

For example, the device definer 120 may set, as the virtual device 410, a DRNcatalyst instance 411 that is an instance generated by DRNcatalyst 311 among the vendor classes 310. The device definer 120 may map the DRNcatalyst instance 411 to a Cisco catalyst switch 421. Here, the DRNcatalyst instance 411 may control the Cisco catalyst switch 421 in response to an instruction included in a common API received from a user.

Also, a program using the virtual device 410 may be a program using a common function not subordinate to a specific vendor.

If a new device of the same type of a business is added, the device definer 120 may define a vendor class of the new device. The device definer 120 may match the vendor class of the new device and an instance of the vendor class of the new device to the new device. Here, a device control apparatus for controlling the actual device 420 using the virtual device 410 may select the instance of the vendor class of the new device as the virtual device 410 corresponding to the new device and thereby control the new device without a need to modify a program using the virtual device 410.

The device definer 120 may generate the virtual device 410 for each version of the actual device 420. In response to a change of the version of the actual device 420, the device definer 120 may easily switch the virtual device 410 by matching the virtual device 410 corresponding to the changed version to the actual device 420.

That is, the integrated management apparatus 100 may generate the virtual device 410 for each version of the actual device 420 in order to manage a product, such as a terminated legacy, not in a person-dependent manner in a situation in which the product needs to be continuously operated.

The integrated management apparatus 100 enables a third party to provide a DRM vendor class. A user using the DRM vendor class provided from the third party may pay a fee to the third party based on an intent of the third part.

Here, the integrated management apparatus 100 may provide a marketplace for matching a provider providing a DRM vendor class and a user using the DRM vendor class.

The integrated management apparatus 100 may expand the range of the actual device 420 supporting the virtual device 410 in response to activation of the marketplace.

If the actual device 420 is a device present in a specific country or a specific region alone, the integrated management apparatus 100 may provide a function of managing the corresponding device to a vendor of the specific country or the specific region so that a user using the corresponding device may receive the benefit coming from the management of the corresponding device.

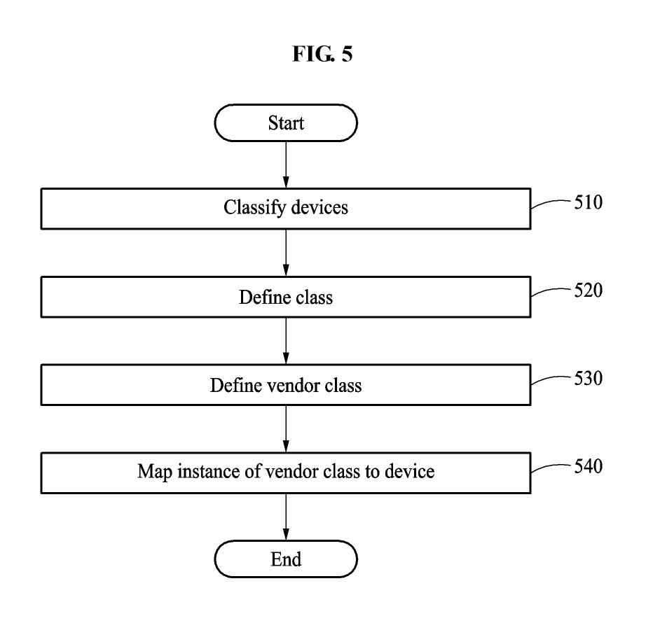

FIG. 5 is a flowchart illustrating an integrated management method for heterogeneous devices according to an example embodiment.

Referring to FIG. 5, in operation 510, the device classifier 110 may classify IP based devices to be managed based on a domain grouped for each field. For example, if a field classified as a domain is “network”, a corresponding field classification may include “router” and “switch” that are detailed items of “network”. Also, if the field classified as the domain is “security”, the corresponding field classification may include “firewall”, “ips”, and “utm” that are detailed items of “security”.

Also, the device definer 120 may form a hierarchical structure of a class so that a detailed item of each classification may be a class of a lower layer of a class corresponding to the corresponding classification.

In operation 530, the device definer 120 may define a class of a bottom class among the hierarchical classes as a vendor class corresponding to a device of a specific vendor.

In operation 540, the device definer 120 may map an instance of the vendor class, a virtual device, to an actual device corresponding to the virtual device.

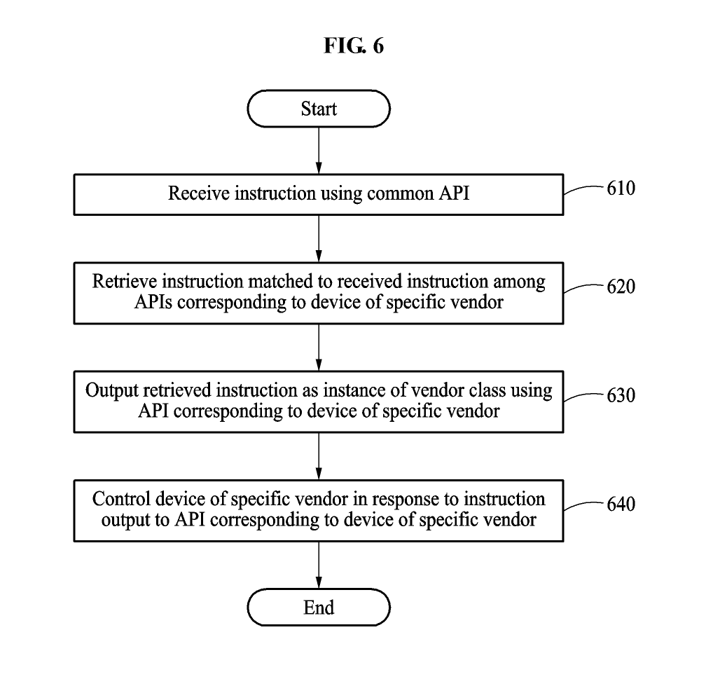

FIG. 6 is a flowchart illustrating a process of controlling, by an instance of a vendor class, a device according to an example embodiment.

An example in which a device control apparatus for controlling the actual device 420 using the virtual device 410 uses the virtual device 131 in order to control the device 101 will be described with reference to FIG. 6.

In operation 610, the device control apparatus may receive an instruction using a common API. The device control apparatus may identify a vendor class and the virtual device 130 matched to the device 101 that is to execute the instruction.

In operation 620, the device control apparatus may retrieve instruction an instruction for performing the same function as the instruction included in the common API received in operation 610 among APIs corresponding to a device of a specific vendor using the identified vendor class. For example, if the vendor class is “DRNcatalyst” and the instruction using the common API is “DRMswitch/set_acl”, the vendor class may retrieve the instruction, “access-list 11 deny tcp 10.20.30.0.0.0.0.255”, which is an instruction for performing the same function as DRMswitch/set_acl as shown in Table 1.

In operation 630, the vendor class may output the retrieved instruction as an instance using an API corresponding to the device of the specific vendor.

In operation 640, the device control apparatus may control the device of the specific vendor matched to the virtual device in response to the instruction output in operation 630. In detail, the device control apparatus may control the device of the specific vendor using the virtual device that is the instance including the instruction output in operation 630.

According to example embodiments, it is possible to manage different heterogeneous devices using a common API by controlling the devices by matching each of instances of a vendor class converting the common API to an API corresponding to a device of a specific vendor, and by converting an instruction input to the common API to an API corresponding to a device to which each of the instances of the vendor class is matched.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An integrated management method for heterogeneous devices, the method comprising:
classifying Internet protocol (IP) based devices to be managed based on a domain grouped for each field;
defining a hierarchical class for each domain based on a field classification corresponding to each domain;
defining a class of a bottom layer among the hierarchical classes as a vendor class corresponding to a device of a specific vendor; and
mapping an instance of the vendor class to the device,
wherein the vendor class converts a common application programming interface (API) of an upper layer to an API corresponding to the device of the specific vendor, and
the device is controlled by the API corresponding to the device of the specific vendor used by the instance of the vendor class.

2. The method of claim 1, wherein a class of a lower layer among the hierarchical classes inherits a common API of a class of the upper layer and includes an API different from those of classes of the same layer.

3. The method of claim 1, wherein the vendor class matches an instruction for performing the same function as an instruction included in the common API of the upper layer among APIs corresponding to the device of the specific vendor to the instruction included in the common API,
in response to receiving the instruction included in the common API of the upper layer, retrieves an instruction that is matched to the received instruction, and
outputs the retrieved instruction as the instance using the API corresponding to the device of the specific vendor.

4. The method of claim 1, wherein the instance is generated for each version of the device of the specific vendor, and an instance matched to the device of the specific vendor is changed in response to a change of a version of the device of the specific vendor.

5. A device control method comprising:
receiving an instruction using a common application programming interface (API);
identifying a vendor class matched to a device that is to execute the instruction;
retrieving an instruction for performing the same function as the received instruction among APIs corresponding to a device of a specific vendor using the identified vendor class; and
controlling the device of the specific vendor using an instance of the identified vendor class in response to the retrieved instruction being output as the instance of the identified vendor class using an API corresponding to the device of the specific vendor.

6. An integrated management apparatus for heterogeneous devices, the apparatus comprising:
a device classifier configured to classify Internet protocol (IP) based devices to be managed based on a domain grouped for each field; and
a device definer configured to define a hierarchical class for each domain based on a field classification corresponding to each domain, to define a class of a bottom layer among the hierarchical classes as a vendor class corresponding to a device of a specific vendor, and to map an instance of the vendor class to the device,
wherein the vendor class converts a common application programming interface (API) of an upper layer to an API corresponding to the device of the specific vendor, and
the device is controlled by the API corresponding to the device of the specific vendor used by the instance of the vendor class.

7. The apparatus of claim 6, wherein a class of a lower layer among the hierarchical classes inherits a common API of a class of the upper layer and includes an API different from those of classes of the same layer.

8. The apparatus of claim 6, wherein the vendor class matches an instruction for performing the same function as an instruction included in the common API of the upper layer among APIs corresponding to the device of the specific vendor, to the instruction included in the common API,
in response to receiving the instruction included in the common API of the upper layer, retrieves an instruction that is matched to the received instruction, and
outputs the retrieved instruction as the instance using the API corresponding to the device of the specific vendor.

9. The apparatus of claim 6, wherein the instance is generated for each version of the device of the specific vendor, and an instance matched to the device of the specific vendor is changed in response to a change of a version of the device of the specific vendor.
